(19) United States
(12) Patent Application Publication
(10) Pub. No.: US 2003/0090987 A1
(43) Pub. Date: May 15, 2003

(54) Objective lens for optical recording medium and optical pickup apparatus

(75) Inventors: You Kitahara, Saitama-shi (JP); Toshiaki Katsuma, Saitama-shi (JP); Tetsuya Ori, Saitama-shi (JP)

Correspondence Address: Ronald R. Snider, Snider & Associates, P.O. Box 27613, Washington, DC, 20038-7613, US

(73) Assignee: Fuji Photo Optical Co., Ltd., Saitama-shi (JP)

(21) Appl. No.: 10/281,260

(22) Filed: Oct. 28, 2002

(30) Foreign Application Priority Data
Oct. 31, 2001 (JP) 2001-334939

(51) Int. Cl. G11B 7/135

(52) U.S. Cl. 369/112.24

(57) ABSTRACT

An objective lens for an optical recording medium comprises two lenses each having a positive refracting power disposed within a laser luminous flux having a wavelength of 360 to 450 nm outputted from a laser diode. The two lenses have at least one diffractive optical surface and at least one aspheric surface, and are set so as to have a total NA of at least 0.7.

### RELATED APPLICATIONS

This application claims the priority of Japanese Patent Application No. 2001-334939 filed on Oct. 31, 2001, which is incorporated herein by reference.

### BACKGROUND OF THE INVENTION

1. Field of the Invention

The present invention relates to an objective lens for an optical recording medium, and an optical pickup apparatus using the same. Specifically, the present invention relates to an objective lens used for an optical recording medium recorded/reproduced by blue-violet laser light having a short wavelength, and an optical pickup apparatus using the same.

2. Description of the Prior Art

As optical recording media which can greatly increase the recording density, attention has recently been given to optical recording media which can be recorded/reproduced by blue-violet laser light having a short wavelength, whereby there has been an urgent need to develop a higher NA (Numerical Aperture) objective lens (optical pickup lens) for recording/reproducing such optical recording media.

In general, however, laser diodes are likely to fluctuate their wavelengths within the range of about ±10 nm due to a mode-hopping phenomenon, whereby their fluctuations are too drastic to be followed by autofocus. Such a mode-hopping phenomenon may be problematic in that chromatic aberration which is not negligible may occur in short-wavelength light in particular, since lens glass materials incur a large refractive index change.

When a higher NA is employed, the focal depth may be so shallow that focusing fluctuations caused by chromatic aberration become more influential.

Known as an objective lens for an optical recording medium for short-wavelength light is one composed of two lenses in which a plurality of lens surfaces are made aspheric as disclosed in Japanese Unexamined Patent Publication No. 2001-83410.

Though this objective lens has higher NA since its number is about 0.85, its measures against chromatic aberration may be insufficient when used for short-wavelength light, thus being too problematic in terms of optical performances to be mounted in optical pickup apparatus aimed at high definition.

As prior art, one having a lens surface formed with an aspheric surface or diffractive optical surface (DOE surface) has also been known (Japanese Unexamined Patent Publication No. HEI 8-62496). However, it is dark since NA is about 0.5, whereas it is composed of a single lens, which is hard to process in order to attain a higher NA. Also, its aimed levels of specs are totally different from those of the present invention. Thus, it cannot be referred to in terms of optical designing.

### SUMMARY OF THE INVENTION

For overcoming the problems mentioned above, it is an object of the present invention to provide an objective lens having a large NA for an optical recording medium adapted to short-wavelength light, which can ameliorate various kinds of aberration such as chromatic aberration even when the wavelength fluctuates due to a mode-hopping phenomenon of a laser diode, and an optical pickup apparatus using the same.

The present invention provides an objective lens for an optical recording medium comprising two lenses each having a positive refracting power disposed within a laser luminous flux having a wavelength of 360 to 450 nm outputted from a laser diode;

wherein the two lenses have at least one diffractive optical surface and at least one aspheric surface, and are set so as to have a total NA of at least 0.7.

Preferably, the optical recording medium has a protective layer with a thickness of 0.2 mm or less located on the entrance side of the laser luminous flux.

Preferably, one of the three lens surfaces successively from the light source side in the lens surfaces of the two lenses is formed with the diffractive optical surface.

Preferably, two of the three lens surfaces successively from the light source side in the lens surfaces of the two lenses are formed with diffractive optical surfaces.

Preferably, the two lenses are formed from the same material.

Preferably, a circular strip division constituting the diffractive optical surface has at least 50 but not greater than 150 circular strips in total.

Preferably, the two lenses comprise, successively from the light source side, a first lens made of a biconvex lens having one convex surface directed onto the light source side and formed with an aspheric surface and a diffractive optical surface, and the other convex surface directed onto the light-converging side and formed with an aspheric surface; and a second lens made of a biconvex lens having one convex surface directed onto the light source side and formed with an aspheric surface, and the other convex surface directed onto the light-converging side which is substantially planar and has a weak power;

wherein a power formed by the two lenses is infinite conjugate.

Preferably, the two lenses comprise, successively from the light source side, a first lens made of a positive meniscus lens having a convex surface directed onto the light source side and formed with an aspheric surface, and a concave surface directed onto the light-converging side and formed with an aspheric surface and a diffractive optical surface; and a second lens made of a biconvex lens having a convex surface directed onto the light source side and formed with an aspheric surface, and a convex surface directed onto the light-converging side;

wherein a power formed by the two lenses is infinite conjugate.

Preferably, the two lenses comprise, successively from the light source side, a first lens made of a biconvex lens having respective convex surfaces directed onto the light source side and light-converging side, each formed with an aspheric surface; and a second lens made of a biconvex lens having a convex surface directed onto the light source side and formed with an aspheric surface and a diffractive optical surface, and a convex surface directed onto the light-converging side;

wherein a power formed by the two lenses is infinite conjugate.

Preferably, the two lenses comprise, successively from the light source side, a first lens made of a biconvex lens having respective convex surfaces directed onto the light source side and light-converging side, each formed with an aspheric surface and a diffractive optical surface; and a second lens made of a positive meniscus lens having a convex surface directed onto the light source side and formed with an aspheric surface, and a concave surface directed onto the light-converging side;

wherein a power formed by the two lenses is infinite conjugate.

Preferably, the two lenses comprise, successively from the light source side, a first lens made of a biconvex lens having a convex surface directed onto the light source side and formed with an aspheric surface and a diffractive optical surface, and a convex surface directed onto the light-converging side and formed with an aspheric surface; and a second lens made of a positive meniscus lens having a convex surface directed onto the light source side and formed with an aspheric surface and a diffractive optical surface, and a concave surface directed onto the light-converging side;

wherein a power formed by the two lenses is infinite conjugate.

Also, the present invention provides an optical pickup apparatus comprising the above-mentioned objective lens for an optical recording medium.

### BRIEF DESCRIPTION OF THE DRAWINGS

FIG. 1A is a schematic view showing the lens configuration of the objective lens in accordance with Example 1 of the present invention, whereas FIG. 1B is an aberration chart thereof showing respective spherical aberrations at various wavelengths;

FIG. 2A is a schematic view showing the lens configuration of the objective lens in accordance with Example 2 of the present invention, whereas FIG. 2B is an aberration chart thereof showing respective spherical aberrations at various wavelengths;

FIG. 3A is a schematic view showing the lens configuration of the objective lens in accordance with Example 3 of the present invention, whereas FIG. 3B is an aberration chart thereof showing respective spherical aberrations at various wavelengths;

FIG. 4A is a schematic view showing the lens configuration of the objective lens in accordance with Example 4 of the present invention, whereas FIG. 4B is an aberration chart thereof showing respective spherical aberrations at various wavelengths;

FIG. 5A is a schematic view showing the lens configuration of the objective lens in accordance with Example 5 of the present invention, whereas FIG. 5B is an aberration chart thereof showing respective spherical aberrations at various wavelengths; and

FIG. 6 is a schematic view showing the objective lens for an optical recording medium and the optical pickup apparatus in accordance with an embodiment of the present invention.

### DESCRIPTION OF THE PREFERRED EMBODIMENTS

In the following, embodiments of the present invention will be explained with reference to the drawings.

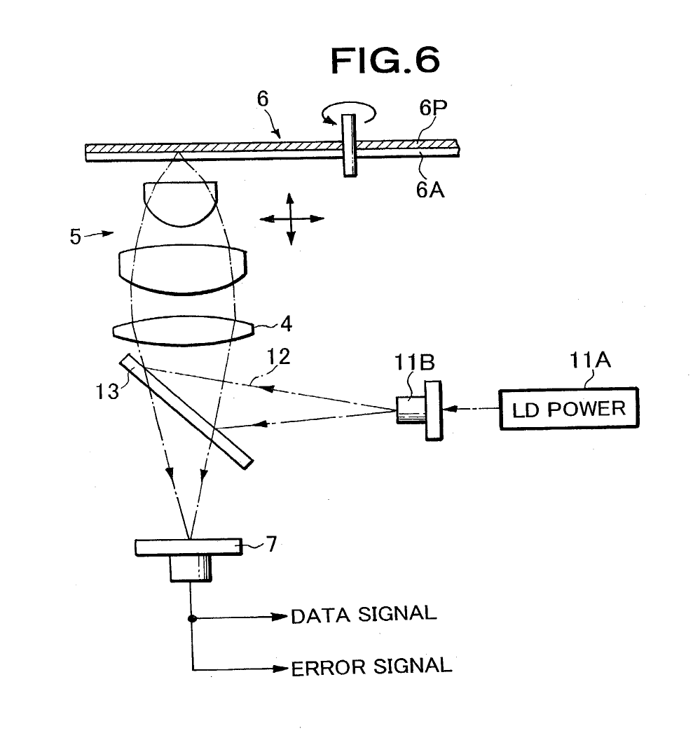

First, with reference to FIG. 6, the objective lens for an optical recording medium and the optical pickup apparatus in accordance with an embodiment of the present invention will be explained.

In this optical pickup apparatus, laser light 12 is outputted from a blue-violet semiconductor laser 11B when power is supplied thereto from an LD power supply 11A. The laser light 12 is reflected by a half mirror 13, and then turned into parallel light by a collimator lens 4. This light is converged by an objective lens 5, so as to irradiate a recording area 6P of an optical disk 6. Here, the semiconductor laser 11B is a laser diode light source for outputting laser light in a blue-violet region having a wavelength of about 405 nm.

In the recording area 6P, pits carrying signal information are arranged like a track, whereby a reproducing light beam of the laser light 12 reflected from the recording area 6P enters the half mirror 13. by way of the objective lens 5 and collimator lens 4 while carrying the signal information, and passes through the half mirror 13, thereby entering a four-part photodiode 7. The photodiode 7 computes the respective quantities of received light at four divided diode positions, thereby attaining a data signal and focus and tracking error signals.

Here, the half mirror 13 is inserted with a tilt of 45° in the optical path of return light from the optical disk 6, thus achieving an operation equivalent of a cylindrical lens, so that the light beam transmitted through the half mirror 13 incurs astigmatism, whereby the focusing error amount is determined according to the beam spot form of the return light on the four-divided photodiode 7. Depending on the circumstances, the collimator lens 4 can be omitted. A grating may further be inserted between the semiconductor laser 11B and the half mirror 13, so that tracking errors can be detected by three beams.

The optical disk 6 has the recording area 6P, and a protective layer 6A having a thickness of 0.2 mm or less laminated on the luminous flux entrance side thereof.

The optical disk 6 can be recorded/reproduced by blue-violet light which can drastically improve the optical recording density. In general, however, laser diodes are likely to fluctuate their wavelengths within the range of about ±10 nm due to a mode-hopping phenomenon, whereby their fluctuations are too drastic to be followed by autofocus. Such a mode-hopping phenomenon may be problematic in that chromatic aberration which is not negligible may occur in short-wavelength light in particular, since lens materials incur a large refractive index change.

When a higher NA is employed, the focal depth may be so shallow that focusing fluctuations caused by chromatic aberration become more influential.

Therefore, the objective lens for an optical recording medium in accordance with this embodiment is configured such that chromatic aberration caused by wavelength fluctuations accompanying mode-hopping can reliably be suppressed while setting a high NA.

Namely, the objective lens for an optical recording medium in accordance with this embodiment is an objective lens comprising two lenses L₁, L₂ each having a positive refracting power, whereas the two lenses L₁, L₂ have at least one diffractive optical surface (DOE surface) and at least one aspheric surface, and are set so as to yield a total NA of at least 0.7.

Selectable as a material constituting the lens is glass or plastic. When glass is selected, the change in performances accompanying the temperature fluctuation can be made smaller. When plastic is selected, on the other hand, excellent processability, lower cost, and lighter weight can be attained.

When the two lenses L₁, L₂ are formed from the same glass material, the material is easier to obtain, which is advantageous in terms of manufacture, thereby achieving a lower cost.

Here, the objective lens 5 is constituted by two lenses, in order to yield a higher NA lens system while facilitating the making of lens.

In the objective lens for an optical recording medium in accordance with this embodiment, at least one surface of the two lenses L₁, L₂ is formed as a diffractive optical surface (DOE surface), whereby the chromatic aberration accompanying a wavelength fluctuation of about ±10 mm can be corrected favorably in particular.

The chromatic aberration correcting effect improves as the number of diffractive optical surfaces (DOE surfaces) is greater.

When forming one surface with a diffractive optical surface (DOE surface), it will be advantageous in terms of chromatic aberration correcting effect if one of the three lens surfaces successively from the light source side (the first, second, and third surfaces from the light source side) in the lens surfaces of two lenses L₁, L₂ is formed with a diffractive optical surface.

When forming two surfaces with diffractive optical surfaces (DOE surfaces), it will be advantageous in terms of chromatic aberration correcting effect if two of the three lens surfaces successively from the light source side (the first, second, and third surfaces from the light source side) in the lens surfaces of two lenses L₁, L₂ are formed with diffractive optical surfaces for the same reason as above.

Preferably, the diffractive optical surface (DOE surface) has 50 to 150 circular strips (not including the central circular area). The chromatic aberration may be corrected in excess if the upper limit of this range is exceeded, whereas the chromatic aberration may not be corrected sufficiently if the lower limit is not satisfied. As a consequence, the chromatic aberration can efficiently be corrected without complicating the making of the lens if the number of circular strips is set within such a range.

It will be more preferable in terms of the correction of chromatic aberration if the number of circular strips is within the range of 80 to 120.

Further, since at least one of the lens surfaces of the two lenses L₁, L₂ is made aspheric, various kinds of aberration such as spherical aberration can be corrected easily.

The aspheric form of the lens surface is represented by the following aspheric surface expression:

$$X = \frac{{Y}^{2} C}{1 + \sqrt{1 - {KY}^{ 2} {C}^{2}}} + {\sum }_{i = 2} {A}_{i} {Y}^{2 i}$$

where Y is the height from the optical axis, K is the conical constant, C is the curvature near the optical axis, and Aᵢ is the 2i-th aspheric surface coefficient.

The form of the diffractive optical surface (DOE) of the lens surface is represented by the following phase difference functional expression, which adds the optical path length difference λφ/2π:

$$φ = {\sum }_{i = 1} {W}_{i} {Y}^{2 i}$$

where Wᵢ is the 2i-th phase difference functional coefficient.

In the following, the above-mentioned objective lens 5 will be explained specifically with reference to Examples 1 to 5.

### EXAMPLES

### Example 1

When the optical disk 6 is disposed at a predetermined position (on a turntable) so as to be recorded/reproduced, laser light 12 having a wavelength of 405 nm is made incident on the objective lens 5 in a state turned into substantially parallel light. Here, the incident laser light 12 is converged by the objective lens 5 onto the recording area 6P of the optical disk 6 (as in the other Examples that follow).

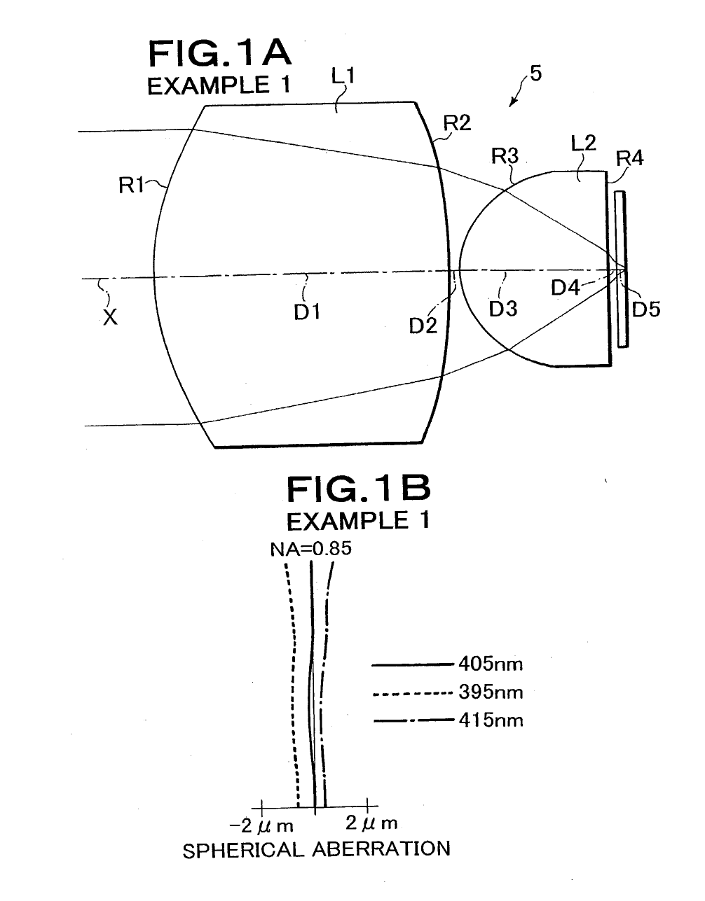

As shown in FIG. 1A, the objective lens 5 in Example 1 comprises, successively from the light source side, a biconvex lens L₁ having one convex surface directed onto the light source side and formed with an aspheric surface (represented by the above-mentioned aspheric surface expression as with the other aspheric surfaces that follow) and a diffractive optical surface (represented by the above-mentioned phase difference function as with the other diffractive optical surfaces that follow), and the other convex surface directed onto the light-converging side and formed with an aspheric surface; and a biconvex lens L₂ having one convex surface directed onto the light source side and formed with an aspheric surface, and the other convex surface directed onto the light-converging side which is substantially planar and has a weak power. Its NA is 0.85, whereas its power is infinite conjugate.

Thus, in the lens surfaces of the objective lens 5, the first, second, and third surfaces from the light source side are formed with aspheric surfaces, whereas the first surface from the light source side is further formed with a diffractive optical surface, whereby chromatic aberration and other kinds of aberration can be made favorable. FIG. 1B shows respective spherical aberrations yielded when the wavelength of light in use is 395 nm, 405 nm, and 415 nm (when the wavelength changes to 395 nm and 415 nm due to mode-hopping while the center wavelength is 405 nm). According to FIG. 1B, the objective lens 5 of Example 1 is favorable in terms of both chromatic aberration and spherical aberration.

The upper part of the following Table 1 shows lens data (radius of curvature R, surface distance D, glass material refractive index N_{λ}, and Abbe number v_{d} at d-line) of the objective lens 5 in accordance with Example 1. It also shows the value of wavelength λ of light in use, focal length f, value of NA, and the number of circular strips of the diffractive optical surface (and its effective diameter φ).

The middle part of Table 1 shows the aspheric surface expression coefficients of each aspheric surface.

The lower part of Table 1 shows the phase difference functional coefficients of the diffractive optical surface.

### Example 2

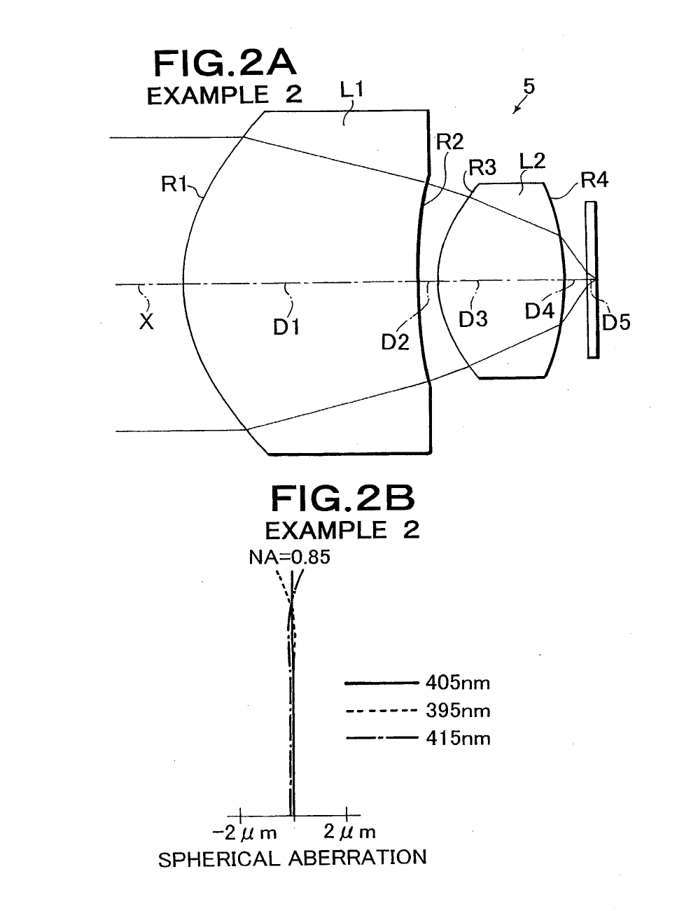

As shown in FIG. 2A, the objective lens 5 in Example 2 comprises, successively from the light source side, a positive meniscus lens L₁ having a convex surface directed onto the light source side and formed with an aspheric surface, and a concave surface directed onto the light-converging side and formed with an aspheric surface and a diffractive optical surface; and a biconvex lens L₂ having a convex surface directed onto the light source side and formed with an aspheric surface, and a convex surface directed onto the light-converging side. Its NA is 0.85, whereas its power is infinite conjugate.

Thus, in the lens surfaces of the objective lens 5, the first, second, and third surfaces from the light source side are formed with aspheric surfaces, whereas the second surface from the light source side is further formed with a diffractive optical surface, whereby chromatic aberration and other kinds of aberration can be made favorable. FIG. 2B shows respective spherical aberrations yielded when the wavelength of light in use is 395 nm, 405 nm, and 415 nm (when the wavelength changes to 395 nm and 415 nm due to mode-hopping while the center wavelength is 405 nm). According to FIG. 2B, the objective lens 5 of Example 2 is favorable in terms of both chromatic aberration and spherical aberration.

The upper part of the following Table 2 shows lens data (radius of curvature R, surface distance D, glass material refractive index N_{λ}, and Abbe number v_{d} at d-line) of the objective lens 5 in accordance with Example 2. It also shows the value of wavelength λ of light in use, focal length f, value of NA, and the number of circular strips of the diffractive optical surface (and its effective diameter φ).

The middle part of Table 2 shows the aspheric surface expression coefficients of each aspheric surface.

The lower part of Table 2 shows the phase difference functional coefficients of the diffractive optical surface.

### Example 3

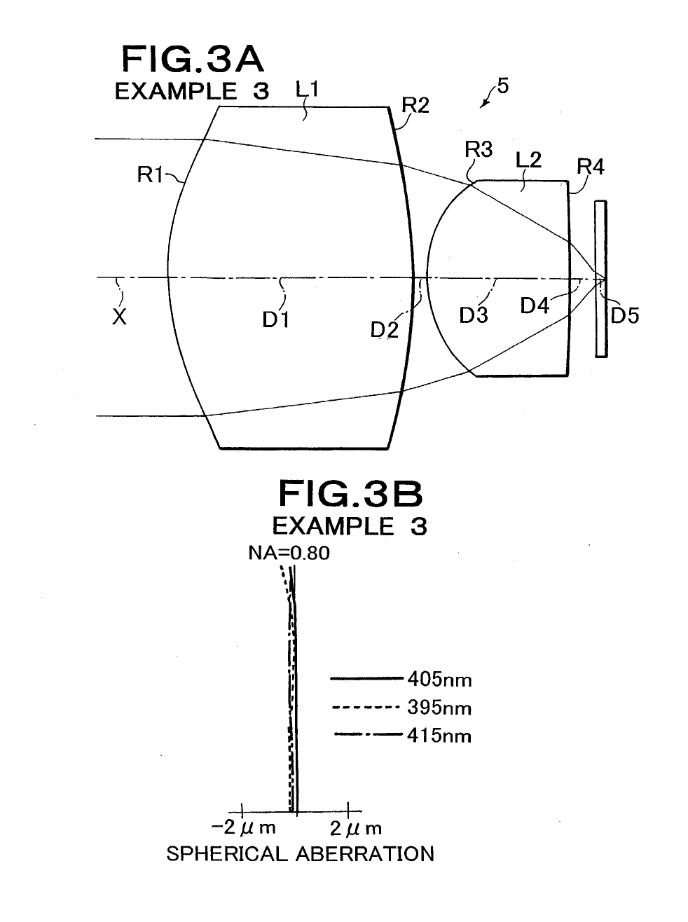

As shown in FIG. 3A, the objective lens 5 in Example 3 comprises, successively from the light source side, a biconvex lens L₁ having respective convex surfaces directed onto the light source side and light-converging side, each formed with an aspheric surface; and a biconvex lens L₂ having a convex surface directed onto the light source side and formed with an aspheric surface and a diffractive optical surface, and a convex surface with a weak power directed onto the light-converging side. Its NA is 0.80, whereas its power is infinite conjugate.

Thus, in the lens surfaces of the objective lens 5, the first, second, and third surfaces from the light source side are formed with aspheric surfaces, whereas the third surface from the light source side is further formed with a diffractive optical surface, whereby chromatic aberration and other kinds of aberration can be made favorable. FIG. 3B shows respective spherical aberrations yielded when the wavelength of light in use is 395 nm, 405 nm, and 415 nm (when the wavelength changes to 395 nm and 415 nm due to mode-hopping while the center wavelength is 405 nm). According to FIG. 3B, the objective lens 5 of Example 3 is favorable in terms of both chromatic aberration and spherical aberration.

The upper part of the following Table 3 shows lens data (radius of curvature R, surface distance D, glass material refractive index N_{λ}, and Abbe number v_{d} at d-line) of the objective lens 5 in accordance with Example 3. It also shows the value of wavelength λ of light in use, focal length f, value of NA, and the number of circular strips of the diffractive optical surface (and its effective diameter φ).

The middle part of Table 3 shows the aspheric surface expression coefficients of each aspheric surface.

The lower part of Table 3 shows the phase difference functional coefficients of the diffractive optical surface.

### Example 4

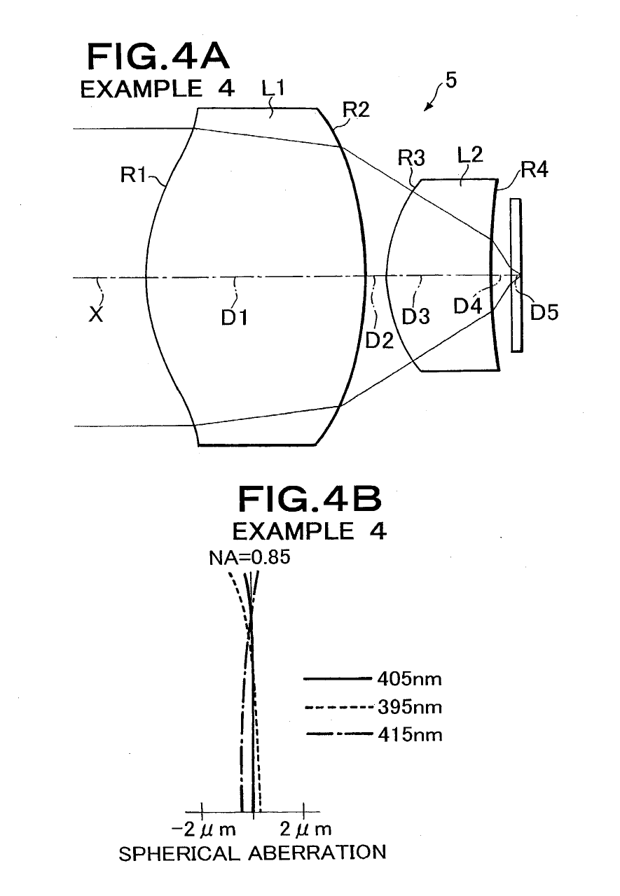

As shown in FIG. 4A, the objective lens 5 in Example 4 comprises, successively from the light source side, a biconvex lens L₁ having respective convex surfaces directed onto the light source side and light-converging side, each formed with an aspheric surface and a diffractive optical surface; and a positive meniscus lens L₂ having a convex surface directed onto the light source side and formed with an aspheric surface, and a concave surface with a weak power directed onto the light-converging side. Its NA is 0.85, whereas its power is infinite conjugate.

Thus, in the lens surfaces of the objective lens 5, the first, second, and third surfaces from the light source side are formed with aspheric surfaces, whereas the first and second surfaces from the light source side are further formed with diffractive optical surfaces, whereby chromatic aberration and other kinds of aberration can be made favorable. FIG. 4B shows respective spherical aberrations yielded when the wavelength of light in use is 395 nm, 405 nm, and 415 nm (when the wavelength changes to 395 nm and 415 nm due to mode-hopping while the center wavelength is 405 nm). According to FIG. 4B, the objective lens 5 of Example 4 is favorable in terms of both chromatic aberration and spherical aberration.

The upper part of the following Table 4 shows lens data (radius of curvature R, surface distance D, glass material refractive index N_{λ}, and Abbe number v_{d} at d-line) of the objective lens 5 in accordance with Example 4. It also shows the value of wavelength λ of light in use, focal length f, value of NA, and the number of circular strips of the diffractive optical surface (and its effective diameter φ).

The middle part of Table 4 shows the aspheric surface expression coefficients of each aspheric surface.

The lower part of Table 4 shows the phase difference functional coefficients of each diffractive optical surface.

### Example 5

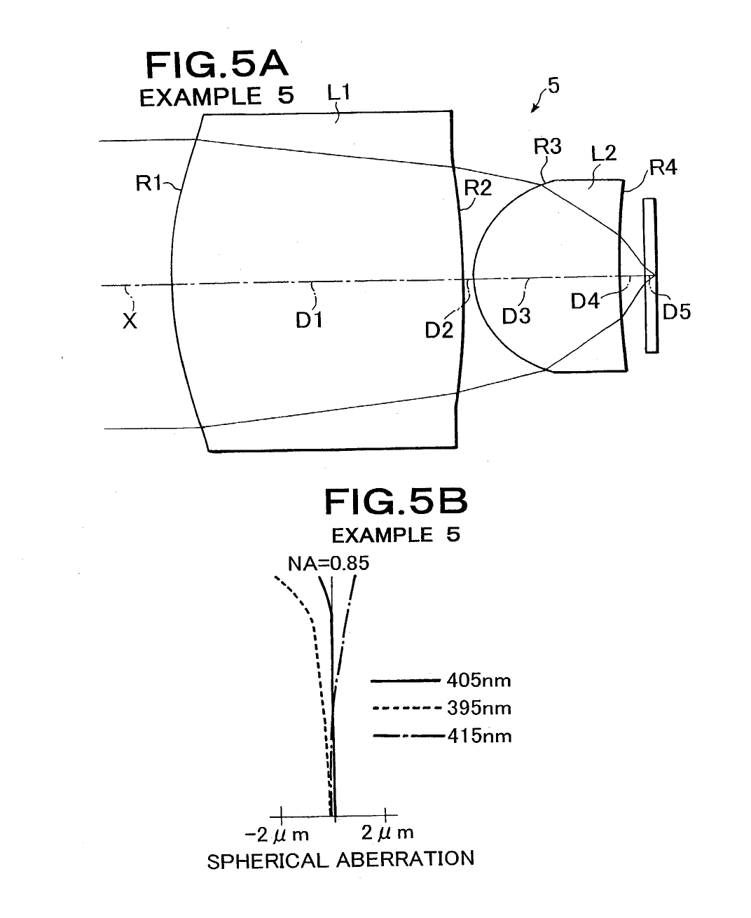

As shown in FIG. 5A, the objective lens 5 in Example 5 comprises, successively from the light source side, a biconvex lens L₁ having a convex surface directed onto the light source side and formed with an aspheric surface and a diffractive optical surface, and a convex surface directed onto the light-converging side and formed with an aspheric surface; and a positive meniscus lens L₂ having a convex surface directed onto the light source side and formed with an aspheric surface and a diffractive optical surface, and a concave surface with a weak power directed onto the light-converging side. Its NA is 0.85, whereas its power is infinite conjugate.

Thus, in the lens surfaces of the objective lens 5, the first, second, and third surfaces from the light source side are formed with aspheric surfaces, whereas the first and third surfaces from the light source side are further formed with diffractive optical surfaces, whereby chromatic aberration and other kinds of aberration can be made favorable. FIG. 5B shows respective spherical aberrations yielded when the wavelength of light in use is 395 nm, 405 nm, and 415 nm (when the wavelength changes to 395 nm and 415 nm due to mode-hopping while the center wavelength is 405 nm). According to FIG. 5B, the objective lens 5 of Example 5 is favorable in terms of both chromatic aberration and spherical aberration.

The upper part of the following Table 5 shows lens data (radius of curvature R, surface distance D, glass material refractive index N_{λ}, and Abbe number v_{d} at d-line) of the objective lens 5 in accordance with Example 5. It also shows the value of wavelength λ of light in use, focal length f, value of NA, and the number of circular strips of the diffractive optical surface (and its effective diameter φ).

The middle part of Table 5 shows the aspheric surface expression coefficients of each aspheric surface.

The lower part of Table 5 shows the phase difference functional coefficients of each diffractive optical surface.

Without being restricted to the above-mentioned embodiment, the objective lens of the present invention can be modified in various manners. For instance, an aspheric surface and a diffractive optical surface may be formed in the fourth surface in addition to or in place of those in the above-mentioned Examples. Also, diffractive optical surfaces may be formed in the second and third surfaces, the three surfaces from the first to third surfaces, or all the surfaces.

Though NA is set to 0.85 and 0.80 in the above-mentioned Examples, it will be sufficient if NA is at least 0.70 in the objective lens for an optical recording medium in accordance with the present invention.

In the objective lens of the present invention and the optical pickup apparatus using the same, as explained in the foregoing, the objective lens for an optical recording medium using short-wavelength light is constituted by two lenses having at least one diffractive optical surface and at least one aspheric surface, while being set so as to have a total NA of at least 0.7.

Thus configured objective lens for an optical recording medium and the optical pickup apparatus using the same employs a diffractive optical surface, thereby being able to attain higher NA and favorable chromatic aberration even when the irradiation light wavelength fluctuates due to a mode-hopping phenomenon of a laser diode.

In addition to the diffractive optical surface, the two lenses have at least one aspheric surface, whereby various kinds of aberration other than chromatic aberration can also be made favorable while facilitating the making of lens.

TABLE 1

| Surface | | | | |
|---|---|---|---|---|
| No. | Radius of curvature R | Center distance D | N_{λ} | ν_{d} |
| 1 | diffractive/ | 2.800 | 1.512790 | 56.09 |
| | aspheric surface | | | |
| 2 | aspheric surface | 0.100 | | |
| 3 | aspheric surface | 1.400 | 1.512790 | 56.09 |
| 4 | −301.6645 | 0.062 | | |
| 5 | 0.0000 | 0.100 | 1.530174 | 64.20 |
| 6 | 0.0000 | 0.000 | | |

Aspheric surface expression coefficient

| | 1^{st} surface | 2^{nd} surface | 3^{rd} surface |
|---|---|---|---|
| K | 0.6768569 | −32.4526458 | 0.8797960 |
| C | 3.5240517 × 10⁻¹ | −1.2958307 × 10⁻¹ | 1.0386338 |
| A₂ | −1.5165197 × 10⁻³ | −2.0925472 × 10⁻² | −1.3637851 × 10⁻² |
| A₃ | −2.3074024 × 10⁻³ | 5.5956055 × 10⁻³ | 5.4418752 × 10⁻² |
| A₄ | −3.1318465 × 10⁻⁴ | 6.9995173 × 10⁻³ | −1.8932004 × 10⁻² |
| A₅ | 5.8156598 × 10⁻⁴ | −6.2875422 × 10⁻³ | 2.8776319 × 10⁻² |
| A₆ | −1.3397833 × 10⁻⁴ | 1.1754503 × 10⁻³ | −2.2157980 × 10⁻² |

Phase difference functional coefficient

| | 1^{st} surface |
|---|---|
| W₁ | −2.0001144 × 10² |
| W₂ | −8.6430932 × 10⁻¹ |
| W₃ | 1.1154573 × 10⁻¹ |
| W₄ | −4.7956729 × 10⁻¹ |
| W₅ | 2.3045765 × 10⁻¹ |

λ = 405 nm
f = 1.775 mm
NA = 0.85
Number of circular strips: 72 (effective diameter: φ = 3.02)

TABLE 2

| Surface | | | | |
|---|---|---|---|---|
| No. | Radius of curvature R | Center distance D | N_{λ} | ν_{d} |
| 1 | aspheric surface | 2.200 | 1.604590 | 60.27 |
| 2 | diffractive/ | 0.200 | | |
| | aspheric surface | | | |
| 3 | aspheric surface | 1.200 | 1.604590 | 60.27 |
| 4 | −2.7064 | 0.200 | | |
| 5 | 0.0000 | 0.100 | 1.529735 | 64.10 |
| 6 | 0.0000 | 0.000 | | |

Aspheric surface expression coefficient

| | 1^{st} surface | 2^{nd} surface | 3^{rd} surface |
|---|---|---|---|
| K | 0.0 | 0.0 | 0.0 |
| C | 4.7187228 × 10⁻¹ | 1.1117466 × 10⁻¹ | 7.2944955 × 10⁻¹ |
| A₂ | 6.8604971 × 10⁻³ | 2.2772539 × 10⁻² | 4.2302047 × 10⁻² |
| A₃ | 1.0512048 × 10⁻³ | 2.1286946 × 10⁻² | 1.6943876 × 10⁻² |
| A₄ | −4.0731973 × 10⁻⁴ | −3.5103610 × 10⁻² | −8.3187539 × 10⁻³ |
| A₅ | −3.1907640 × 10⁻⁵ | 1.8119118 × 10⁻² | −3.7229231 × 10⁻² |

Phase difference functional coefficient

| | 2^{nd} surface |
|---|---|
| W₁ | −6.0326440 × 10² |
| W₂ | 3.4645713 |
| W₃ | −8.5171221 |
| W₄ | 8.6298363 |
| W₅ | −3.0713880 |

λ = 405 nm
f = 1.760 mm
NA = 0.85
Number of circular strips: 100 (effective diameter: φ = 2.04)

TABLE 3

| Surface | | | | |
|---|---|---|---|---|
| No. | Radius of curvature R | Center distance D | N_{λ} | ν_{d} |
| 1 | aspheric surface | 2.321 | 1.512790 | 56.09 |
| 2 | aspheric surface | 0.117 | | |
| 3 | diffractive/ | 1.337 | 1.512790 | 56.09 |
| | aspheric surface | | | |
| 4 | −35.1113 | 0.240 | | |
| 5 | 0.0000 | 0.100 | 1.529735 | 64.10 |
| 6 | 0.0000 | | | |

Aspheric surface expression coefficient

| | 1^{st} surface | 2^{nd} surface | 3^{rd} surface |
|---|---|---|---|
| K | 0.0 | 0.0 | −0.0760039 |
| C | 3.7441440 × 10⁻¹ | −2.3417817 × 10⁻¹ | 6.8577385 × 10⁻¹ |
| A₂ | −6.2555969 × 10⁻³ | 5.1841819 × 10⁻² | 1.0287926 × 10⁻¹ |
| A₃ | 9.2268374 × 10⁻⁴ | −3.7507984 × 10⁻² | 7.5640277 × 10⁻³ |
| A₄ | −1.6599542 × 10⁻³ | 1.3809938 × 10⁻² | 1.7368655 × 10⁻² |
| A₅ | 3.0939715 × 10⁻⁴ | −1.8716079 × 10⁻³ | 2.2778721 × 10⁻³ |

Phase difference functional coefficient

| | 3rd surface |
|---|---|
| W₁ | −6.0032743 × 10² |
| W₂ | −1.4193991 × 10² |
| W₃ | −3.3749928 × 10⁻¹ |
| W₄ | −2.3955165 |
| W₅ | 7.0745671 × 10⁻² |

λ = 405 nm
f = 1.760 mm
NA = 0.80
Number of circular strips: 104 (effective diameter: φ = 1.90)

TABLE 4

| Surface | | | | |
|---|---|---|---|---|
| No. | Radius of curvature R | Center distance D | N_{λ} | ν_{d} |
| 1 | diffractive/ | 2.100 | 1.604590 | 60.27 |
| | aspheric surface | | | |
| 2 | diffractive/ | 0.200 | | |
| | aspheric surface | | | |
| 3 | aspheric surface | 1.000 | 1.604590 | 60.27 |
| 4 | 7.3847 | 0.200 | | |
| 5 | 0.0000 | 0.100 | 1.529735 | 64.10 |
| 6 | 0.0000 | | | |

Aspheric surface expression coefficient

| | 1^{st} surface | 2^{nd} surface | 3^{rd} surface |
|---|---|---|---|
| K | 0.0 | 0.0 | 0.0 |
| C | 4.6488915 × 10⁻¹ | −2.1139762 × 10⁻¹ | 5.9893776 × 10⁻¹ |
| A₂ | −2.2576503 × 10⁻³ | −1.0330501 × 10⁻² | 1.0368651 × 10⁻² |
| A₃ | −2.9053915 × 10⁻³ | −3.2315752 × 10⁻³ | 1.0849261 × 10⁻² |
| A₄ | −8.3388298 × 10⁻⁴ | 1.1331687 × 10⁻³ | 9.3727006 × 10⁻³ |
| A₅ | −2.1012815 × 10⁻⁴ | −1.9957916 × 10⁻⁴ | 7.4087354 × 10⁻³ |

Phase difference functional coefficient

| | 1^{st} surface | 2^{nd} surface |
|---|---|---|
| W₁ | −2.3977669 × 10² | −9.7178115 × 10¹ |
| W₂ | −1.3994989 × 10⁻⁵ | −7.1811054 × 10⁻⁶ |
| W₃ | −4.4137881 × 10⁻⁵ | −1.4013646 × 10⁻⁵ |
| W₄ | −1.2298247 × 10⁻⁴ | −2.5393033 × 10⁻⁵ |
| W₅ | −3.2027923 × 10⁻⁴ | −4.3357475 × 10⁻⁵ |

λ = 405 nm
f = 1.760 mm
NA = 0.85
Number of circular strips of 1^{st} surface: 90 (effective diameter: φ = 3.08)
Number of circular strips of 2^{nd} surface: 28 (effective diameter: φ = 2.70)
Total number of circular strips: 118

TABLE 5

| Surface | | | | |
|---|---|---|---|---|
| No. | Radius of curvature R | Center distance D | N_{λ} | ν_{d} |
| 1 | diffractive/ | 2.800 | 1.512790 | 56.09 |
| | aspheric surface | | | |
| 2 | aspheric surface | 0.100 | | |
| 3 | diffractive/ | 1.400 | 1.512790 | 56.09 |
| | aspheric surface | | | |
| 4 | 11.3990 | 0.239 | | |
| 5 | 0.0000 | 0.100 | 1.530174 | 64.20 |
| 6 | 0.0000 | | | |

Aspheric surface expression coefficient

| | 1^{st} surface | 2^{nd} surface | 3^{rd} surface |
|---|---|---|---|
| K | 0.6768116 | −32.4526966 | 0.8003804 |
| C | 2.3969224 × 10⁻¹ | −1.0042277 × 10⁻¹ | 1.0393345 |
| A₂ | 1.7425473 × 10⁻³ | −1.5624468 × 10⁻² | −1.6691773 × 10⁻² |
| A₃ | −6.5473978 × 10⁻³ | 8.5737833 × 10⁻³ | 5.1374950 × 10⁻² |
| A₄ | 2.6555408 × 10⁻³ | 6.0832197 × 10⁻³ | −1.9453293 × 10⁻² |
| A₅ | −2.6120967 × 10⁻⁴ | −7.5138305 × 10⁻³ | 2.9433868 × 10⁻² |
| A₆ | −4.8501946 × 10⁻⁵ | 2.1937325 × 10⁻³ | −2.1328825 × 10⁻² |

Phase difference functional coefficient

| | 1^{st} surface | 3^{rd} surface |
|---|---|---|
| W₁ | −1.9978794 × 10² | −1.4972058 × 10² |
| W₂ | −8.6536853 × 10⁻¹ | 1.2271185 × 10⁻³ |
| W₃ | 1.1288529 × 10⁻¹ | 9.1956985 × 10⁻⁴ |
| W₄ | −4.8037922 × 10⁻¹ | 4.0601385 × 10⁻⁵ |
| W₅ | 2.3096227 × 10⁻¹ | −2.8783164 × 10⁻⁴ |

λ = 405 nm
f = 1.760 mm
NA = 0.85
Number of circular strips of 1^{st} surface: 71 (effective diameter: φ = 2.99)
Number of circular strips of 3^{rd} surface: 21 (effective diameter: φ = 1.92)
Total number of circular strips: 92

What is claimed is:

1. An objective lens for an optical recording medium, said objective lens comprising two lenses each having a positive refracting power disposed within a laser luminous flux having a wavelength of 360 to 450 nm outputted from a laser diode;
wherein said two lenses have at least one diffractive optical surface and at least one aspheric surface, and are set so as to have a total NA of at least 0.7.

2. An objective lens for an optical recording medium according to claim 1, wherein said optical recording medium has a protective layer with a thickness of 0.2 mm or less located on the entrance side of said laser luminous flux.

3. An objective lens for an optical recording medium according to claim 1, wherein one of the three lens surfaces successively from the light source side in the lens surfaces of said two lenses is formed with said diffractive optical surface.

4. An objective lens for an optical recording medium according to claim 1, wherein two of the three lens surfaces successively from the light source side in the lens surfaces of said two lenses are formed with diffractive optical surfaces.

5. An objective lens for an optical recording medium according to claim 1, wherein said two lenses are formed from the same material.

6. An objective lens for an optical recording medium according to claim 1, wherein a circular strip division part constituting said diffractive optical surface has at least 50 but not greater than 150 circular strips in total.

7. An objective lens for an optical recording medium according to claim 1, wherein said two lenses comprise, successively from the light source side, a first lens made of a biconvex lens having one convex surface directed onto the light source side and formed with an aspheric surface and a diffractive optical surface, and the other convex surface directed onto the light-converging side and formed with an aspheric surface; and a second lens made of a biconvex lens having one convex surface directed onto the light source side and formed with an aspheric surface, and the other convex surface directed onto the light-converging side which is substantially planar and has a weak power;
wherein a power formed by said two lenses is infinite conjugate.

8. An objective lens for an optical recording medium according to claim 1, wherein said two lenses comprise, successively from the light source side, a first lens made of a positive meniscus lens having a convex surface directed onto the light source side and formed with an aspheric surface, and a concave surface directed onto the light-converging side and formed with an aspheric surface and a diffractive optical surface; and a second lens made of a biconvex lens having a convex surface directed onto the light source side and formed with an aspheric surface, and a convex surface directed onto the light-converging side;
wherein a power formed by said two lenses is infinite conjugate.

9. An objective lens for an optical recording medium according to claim 1, wherein said two lenses comprise, successively from the light source side, a first lens made of a biconvex lens having respective convex surfaces directed onto the light source side and light-converging side, each formed with an aspheric surface; and a second lens made of a biconvex lens having a convex surface directed onto the light source side and formed with an aspheric surface and a diffractive optical surface, and a convex surface directed onto the light-converging side;
wherein a power formed by said two lenses is infinite conjugate.

10. An objective lens for an optical recording medium according to claim 1, wherein said two lenses comprise, successively from the light source side, a first lens made of a biconvex lens having respective convex surfaces directed onto the light source side and light-converging side, each formed with an aspheric surface and a diffractive optical surface; and a second lens made of a positive meniscus lens having a convex surface directed onto the light source side and formed with an aspheric surface, and a concave surface directed onto the light-converging side;
wherein a power formed by said two lenses is infinite conjugate.

11. An objective lens for an optical recording medium according to claim 1, wherein said two lenses comprise, successively from the light source side, a first lens made of a biconvex lens having a convex surface directed onto the light source side and formed with an aspheric surface and a diffractive optical surface, and a convex surface directed onto the light-converging side and formed with an aspheric surface; and a second lens made of a positive meniscus lens having a convex surface directed onto the light source side and formed with an aspheric surface and a diffractive optical surface, and a concave surface directed onto the light-converging side;
wherein a power formed by said two lenses is infinite conjugate.

12. An optical pickup apparatus comprising the objective lens for an optical recording medium according to claim 1.
